(19) United States
(12) Patent Application Publication
(10) Pub. No.: US 2008/0243610 A1
(43) Pub. Date: Oct. 2, 2008

(54) Attention estimation through incremental impression interaction for precise advertisement monetization

(75) Inventors: Robert J. Ragno, Kirkland, WA (US); Rishi Bal, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,059

(22) Filed: Mar. 28, 2007

(51) Int. Cl. G06Q 30/00; G06F 3/048

(52) U.S. Cl. 705/14; 715/856

(57) ABSTRACT

An advertising package can contain multiple levels of advertisements ranging from small, unobtrusive ads at initial levels, to larger, more complex and more informative ads at subsequent levels. Viewers of a web page, or users of an ad-sponsored program, can initially be presented with a first level advertisement. User triggering actions can cause the display of a subsequent level advertisements that can provide further information without leaving the context of the web page or ad-sponsored program. The levels of advertisements displayed to a user can offer a more precise measure of user interest, and can be the basis by which future ad packages are tuned, and can be the basis of more tiered financial agreements between the advertiser and the publisher.

### BACKGROUND

The core of the World Wide Web (WWW) comprises several billion interlinked web pages which are visited by over a billion people. As such, web pages, especially popular web pages, provide a powerful advertising medium. Traditionally, the financial aspects of web page advertising have either been based on the number of “views” of the ad, the number of “click-throughs” occurring through the ad, or some combination thereof. Because it was traditionally considered impossible to track what any given visitor to a web page actually looks at, the mere fact that a visitor viewed the web page was generally counted as a “view” of an advertisement displayed on the web page at that time. Conversely, a “click-through” required not just that a visitor to the web page saw and read the ad, but that they actually clicked on the ad, thereby suspending their visit to the web page and instead visiting the advertiser's web page, or whatever other web page may be linked with the advertisement.

As web-based advertising matured, the financial compensation based on ad views was commonly reduced to a small amount, as empirical data showed a weak correlation between the number of views of an advertisement and an attendant increase in the advertiser's sales. Click-throughs, on the other hand, maintained a much higher level of compensation because, as expected, individuals who were so interested in the advertised product that they left the website they had intended to visit, and instead visited the advertiser's web site, often did end up purchasing the advertised product or service. Click-throughs likewise formed the basis by which web-based advertising was tuned by advertisers. Advertisements that generated click-throughs were expanded upon, while those that failed to generate click-throughs were discarded.

Just as advertisers sought to display web-based ads that were interesting to viewers so as to entice them to purchase the advertised product, the publishers of the content provided on web pages that hosted those ads likewise sought to display web-based ads that were interesting to the readers of the web page. Advertisements that are not interesting to the visitor of a web page are often annoying or, at best, distracting. Visitors that are repeatedly annoyed by the advertisements on a web page can choose to stop visiting the web page, thereby decreasing the web page's popularity and, ultimately, impacting the income received by the web page publisher for the web page. However, like advertisers, web page publishers were often limited to the use of click-throughs for gauging visitor reaction to the advertisements displayed on the publisher's web page.

Although not as prevalent, ad-supported software utilized a similar model even prior to web-based advertisements. Such ad-supported software was provided for free to users, but would display advertisements as the user interacted with the software. As with web-based advertisements, the software developer could be compensated either based on the number of times that an ad was displayed to a user, the number of times that the user clicked on the ad, or some combination thereof. Again, as with web-based advertisements, both the advertiser and the software developer sought to display ads that would be interesting for the user, and both generally gauged that interest by monitoring the user's clicking on an ad.

### SUMMARY

A greater amount of information regarding user reactions to displayed advertisements can be collected by providing incrementally increasing levels of advertisements, with each level comprising a greater amount of information and presentation. Initial advertisements can be small and unobtrusive. A user action that indicates some measure of interest can trigger a subsequently larger and more obtrusive advertisement which can provide the user with a greater amount of information, but can still be presented within the context of the user's primary goal, such as reading a web site or interacting with an ad-sponsored software application. Increasingly larger and more informative advertisements can be displayed in response to user actions that indicate a desire to continue to gather more information regarding the advertised product or service. Ultimately, the user can be directed to an advertiser web site or similar destination in an similar manner to a traditional click-through. By providing incrementally greater interaction with an advertisement package, the user's interest in the advertising can be more accurately gauged and recorded. More specifically, user interest can be quantified even if it does not extend to the level needed to cause the user to set aside their primary goal, such as reading the web site, and instead click-through to the advertiser's web site.

The user's interaction with each of the varying levels of an advertisement package can be recorded by the application with which the user is currently interacting, such as a web browser or an ad-sponsored software package; and this information can be stored locally or sent to one or more servers, such as the servers that provided the ad package in the first place. User interaction data can be aggregated and provided on a per-advertiser basis to the advertiser and on a per-web-page or per-publisher basis to the publisher of the web page, or on a per-program basis to the developer of the ad-sponsored software. In each case, the data can be used to more effectively tune the advertising. The publisher and developer can use the data to more accurately gauge user interest in the advertisements that are being displayed. The advertiser can use the data to more accurately gauge user interest in the advertising package. The data can also be used to establish a more tiered, and thus more negotiable, financial agreement between the advertiser and the publisher or software developer.

This record of user interest and interaction can serve as the foundation for additional functionality that can be of value to users. For example, with an appropriate interface, users can be provided a mechanism with which to recall the advertisements for which they showed a given level of interest. Such an interface can provide functionality similar to “bookmarking” but it can be advertisement-focused and more lightweight and automatic, since the user would not need to explicitly bookmark the advertisement. Users can also be provided with mechanisms with which to recall any other aspects of their advertisement interactions, such as the context in which the user encountered any particular advertisement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary system that provides context for the described functionality;

FIG. 2 is a block diagram of an exemplary computing device;

FIG. 3 is an illustration of an exemplary of a web page having space provisions for multiple levels of advertisements;

FIG. 4 is a flow diagram illustrating an exemplary presentation of multiple levels of advertisements in response to user actions;

FIG. 5 is a communicational diagram illustrating an exemplary process communicational flow providing multiple levels of advertisements; and

FIG. 6 is a flowchart illustrating an exemplary process for providing and recording responses to multiple levels of advertisements.

### DETAILED DESCRIPTION

The following description relates to providing multiple levels of advertisements to more accurately gauge user or visitor interest. In one embodiment, web pages, ad-sponsored software, or other ad-hosting mechanisms can provide increasingly informative levels of advertising in response to user behavior that evidences an interest in the previously provided advertising level. If, at any level, the user does not evidence an interest in the advertisement, then no further levels need to be presented. The highest level presented to a user, therefore, provides a more finely grained gauge of the user's interest in the advertised product or service. Information regarding the highest level reached by users of a particular program, or visitors to a particular web page, can be used by both the advertiser and the developer of the program, or publisher of the web page, to tune the types of ads presented to those users or visitors. Such information can likewise be used to establish more flexible financial terms for the advertising.

The techniques described herein focus on the presentation of multiple levels of advertisements in response to predefined user actions, and the collection of information regarding the presentation of such levels to particular users. The techniques described herein further focus on the flexibility afforded to publishers, software developers, and advertisers because of the multiple advertisement level information collected. While the described techniques are illustrated within the context of a web page, they are intended to cover any type of ad-hosting mechanism, including, for example, ad-sponsored software. Similarly, while the described techniques suggest particular visual presentations, they are not limited to such visual elements, and can be implemented using any appropriately selected visual cues and visual information presentation mechanisms.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing devices, as the mechanisms may also be practiced in distributed computing environments where tasks are performed by remote processing devices that are linked through a communications network. In a distributed computing environment, program modules may be located in both local and remote memory storage devices.

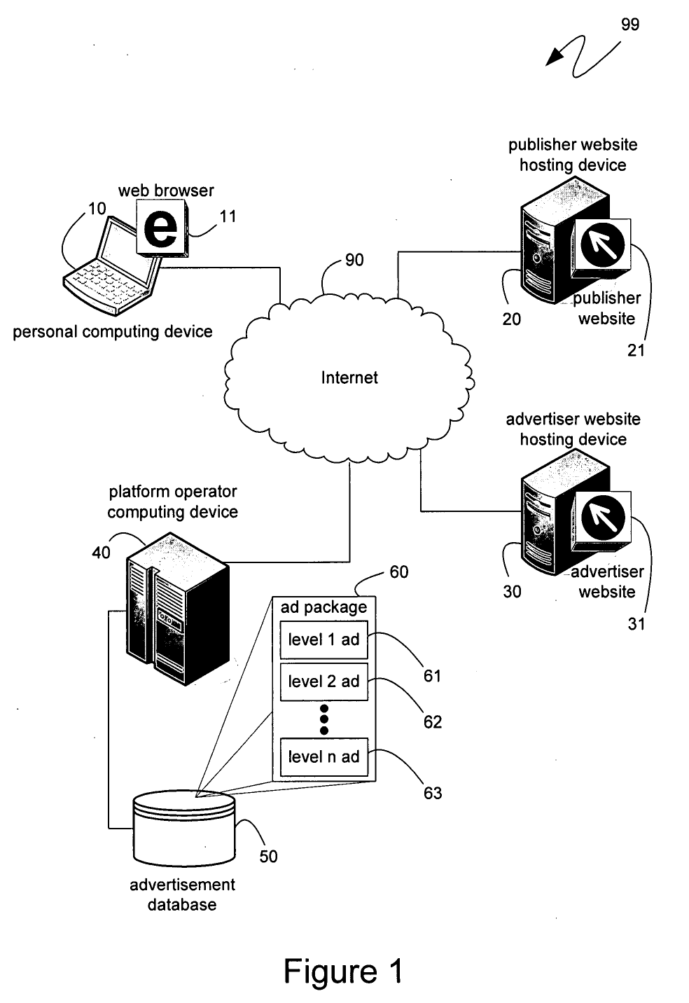

With reference to FIG. 1, an exemplary system 99 is illustrated, providing context for the descriptions below. The exemplary system 99 can be part of the Internet 90, as illustrated, though the reference to the Internet is strictly an example and is not intended to limit the descriptions to Internet protocols, such as the Transmission Control Protocol (TCP), the Internet Protocol (IP), or any other Internet-specific technology. Exemplary system 99 includes a personal computing device 10 and website hosting computing devices 20 and 30 connected to the Internet 90. Each of the website hosting devices 20 and 30 hosts a website 21 and 31, respectively, which can be browsed from the personal computing device 10 with a web browser 11. More precisely, the various web pages of websites 21 and 31 can be read and displayed by web browser 11. As will be known by those skilled in the art, the collection of websites hosted by computing devices connected to the Internet 90 is commonly referred to as the World Wide Web. However, as with the reference to the Internet itself, the reference to the World Wide Web is strictly exemplary and is not intended to limit the descriptions to HTTP, HTML, or any other World Wide Web-specific technology.

Also illustrated in FIG. 1 is a platform operator computing device 40 which hosts an advertisement database 50 comprising one or more ad packages, such as ad package 60. The ad package 60, in turn, comprises one or more advertisements designed for varying levels of display, with each successive level providing for a greater amount of advertising data. For example, the ad package 60 comprises advertisements 61, 62 and 63 directed to at least three distinct levels. Advertisement 61 of the ad package 60 can be a first level ad and can, for example, comprise a limited amount of advertising data designed to be displayed in an unobtrusive manner and to provide a only minimum of information intended to pique a viewer's interest. Advertisement 62 of the ad package 60 can be a second level ad and can comprise a greater amount of advertising data than ad 61. For example, the second level ad 62 can comprise information designed to describe or display the product or service being advertised while still conforming to a limited amount of display space. Advertisement 63 of the ad package 60 can be a last level ad and can comprise the most amount of advertising data of any advertisement in the ad package 60. Such advertising data need not, necessarily, comprise a greater amount of consumable information, but can instead simply comprise presentation formats that require a large amount of data, such as audio or video presentations. Thus, for example, the advertisement 63 can comprise a multi-media rich presentation, such as might be displayed in a separate window provided by the web browser 11.

In one embodiment, a web page from the publisher website 21 can host one or more of the ad packages, such as ad package 60, obtained from the platform operator computing device 40. More specifically, the web page from the publisher website 21 can link to the platform operator computing device 40 such that a request by the web browser 11 to display the web page results in the transmission of an ad package 60 from the platform operator computing device to the personal computing device 10, either directly, or by first being transmitted to the publisher website hosting device 20. The advertisements 61, 62 and 63 of the ad package 60 can be selectively displayed by the web browser 11 in response to user actions. For example, advertisement 61 can be displayed initially as part of the web page requested from the publisher website 21. If the user performs an action that evidences an interest in the advertisement 61, the web browser 11 can display advertisement 62. Logic for implementing such a decision-based functionality is well known in the art and includes common browser-understandable scripting tools such as JavaScript and AJAX.

Upon display of an advertisement, such as ad 62, the web browser 11 can notify the platform operator computing device, either directly or indirectly through the publisher website hosting device, of the display of the advertisement. Such data can be collected by the platform operator computing device, amalgamated, and subsequently provided to either or both the publisher and the advertiser. The amalgamated data can then be used to determine the requisite level of compensation to be provided by the advertiser to the publisher, and can also be used by both the publisher and the advertiser to tune the advertisements provided to a visitor.

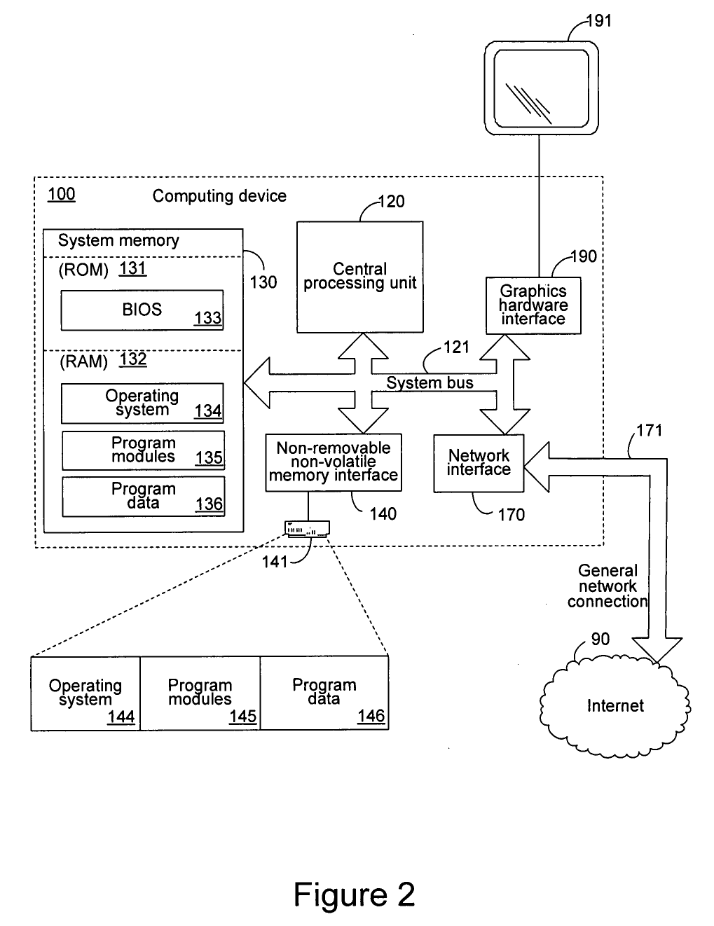

Turning to FIG. 2, an exemplary computing device 100 is illustrated. Any of the computing devices of system 99 shown in FIG. 1 can be of the form of the exemplary computing device 100, including the personal computing device 10, the website hosting devices 20 and 30, and the platform operator computing device 40.

The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include the Peripheral Component Interconnect (PCI) bus and various higher speed versions thereof, the Industry Standard Architecture (ISA) bus and Enhanced ISA (EISA) bus, the Micro Channel Architecture (MCA) bus, and the Video Electronics Standards Associate (VESA) bus. The computing device 100 can optionally include graphics hardware, including, but not limited to, a graphics hardware interface 190 and a display device 191.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing operating system 144, other program modules 145, and program data 146. Note that these components can either be the same as or different from operating system 134, other program modules 135 and program data 136. Operating system 144, other program modules 145 and program data 146 are given different numbers hereto illustrate that, at a minimum, they are different copies.

Of relevance to the descriptions below, the computing device 100 may operate in a networked environment using logical connections to one or more remote computers. For simplicity of illustration, and in conformance with the exemplary system 99 of FIG. 1, the computing device 100 is shown in FIG. 2 to be connected to the Internet 90. However, the computing device 100 is not limited to any particular network or networking protocols. The logical connection depicted in FIG. 2 is a general network connection 171 that can be a local area network (LAN), a wide area network (WAN) or other networks. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

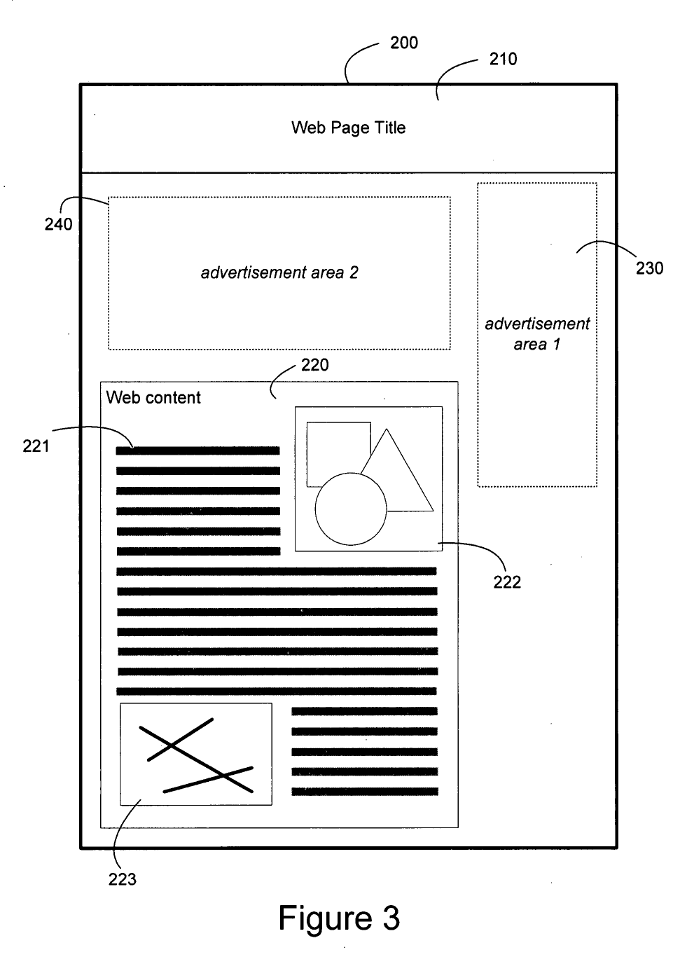

In a World Wide Web based environment, network communications occur generally within the context of the display of one or more web pages. Turning to FIG. 3, an exemplary web page 200 is shown providing areas 230 and 240 for the display of advertisements. The exemplary web page 200 could be any type of web page, including, but not limited to, search web pages, informational web pages, static web pages, blog or journal web pages, forum web pages or any other type of web page. For illustration purposes, the exemplary web page 200 is shown as an informational web page, comprising a web page title area 210 and informational content 220. Because of the hypermedia nature of web pages, the informational content 220 can comprise text 221, including links to other web pages, and images 222 and 223. Though not shown, the exemplary web page 200 could likewise comprise audio or video information as well.

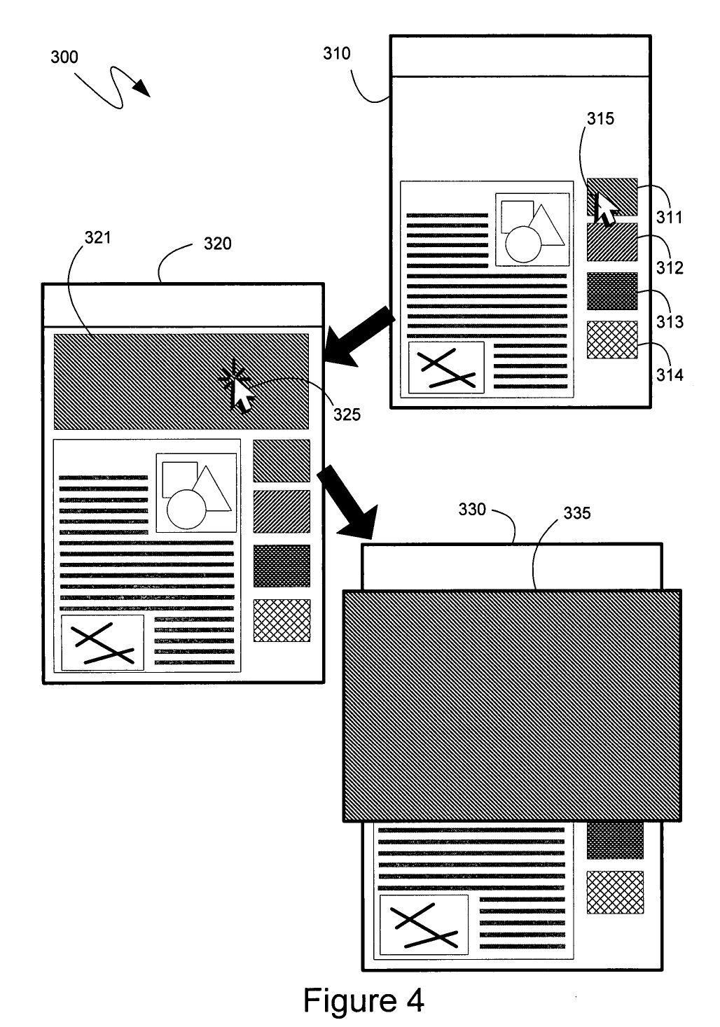

An exemplary user experience flow 300 is illustrated in FIG. 4 in the context of the exemplary web page 200 of FIG. 3. Web page 310 of FIG. 4 represents an initial presentation to the user of the exemplary web page 200 of FIG. 3, with the addition of advertisements 311, 312, 313 and 314 in advertising area 230. As illustrated, the advertisements 311, 312, 313 and 314 can consume a minimum amount of space on the web page 310, thereby enabling the publisher to place additional advertisements, and thereby possibly generate additional advertising revenue, while not distracting a visitor of the web page 310 from the primary content of the web page. Each of the advertisements 311, 312, 313 and 314 can be a first level ad of an ad package, such as advertisement 61 of the ad package 60 illustrated in FIG. 1.

A visitor to web page 310 can notice the advertisements 311, 312, 313 and 314, and can, to receive more information, take some action with respect to the particular advertisement that piqued that visitor's interest. In one embodiment, such an action requires nothing more than a “hover,” whereby the visitor simply moves their web browser's cursor into the area of the web page displaying the advertisement. For example, the visitor could simply hover their cursor 315 over an advertisement, such as ad 311, as shown in FIG. 4. Such a hover can trigger the display of a second level advertisement, such as ad 321 shown in web page 320. The advertisement 321 can be a second level ad from the same ad package as the first level ad 311 on which the user action was performed.

As shown in FIG. 4, web pages 310 and 320 comprise the same fundamental web page, with web page 320 simply adding the display of advertisement 321 in the advertising area 240. Thus, a visitor to web page 310 can, upon seeing an advertisement that piques their interest, efficiently obtain more information about the advertised product or service through a second level advertisement, such as ad 321, without ever leaving the context of the web page. In one embodiment, the data for the second level advertisement, or even the entire ad package, can have already been downloaded. Consequently, a triggering event on advertisement 311 can result in a nearly instantaneous display of advertisement 321. Furthermore, because the primary content of the web pages 310 and 320 remains visible, if the visitor determines, after viewing advertisement 321, that they are not interested in the advertised product or service, they can return to viewing the primary content of the web page without any delay or any action. In one embodiment, if the visitor's cursor leaves the area defined by advertisement 311, the second level ad 321 can disappear, further reducing the distractions to the visitor.

If, however, the visitor decides that they desire to learn yet more information about the advertised product or service after viewing the second level ad 321, the visitor can perform another yet another triggering action, this time with respect to advertisement 321. For example, as shown in FIG. 4, the visitor can click an appropriate location of the advertisement 321 with the cursor 325 to cause a still further level advertisement to be displayed. Web page 330 of FIG. 4 illustrates a third level advertisement 335 in a separate “pop-up” window. The third level ad 335 can be from the same ad package as advertisements 321 and 311, and can contain more data than either of those two lower level ads. Such greater data need not manifest itself in the form of greater informational content, but can instead, simply comprise a richer presentation. For example, advertisement 335 can comprise animation, audio, video or other multimedia. As can be seen from web page 330, advertisement 335 can also occupy a greater amount of space. Nevertheless, web page 330 remains the same fundamental web page as web pages 320 and 310 and the visitor can quickly return to their primary purpose in visiting the web page by merely closing the window comprising advertisement 335.

As can be seen, by providing multiple levels of advertisements within a single ad package, a visitor to a web page can obtain more information regarding the advertised product or service without leaving the context of the web page or deviating from their intended purpose in visiting the web page in the first place. In addition, the publisher of a web page can select to display a greater amount of advertising, since the first level advertisements for ad packages can be small and unobtrusive.

In addition, by providing multiple levels of advertisements, a greater level of detail can be obtained regarding a user's interest. More specifically, visitors to a web page can initiate the display of a second level ad even if they were not sufficiently interested in the first level ad to visit the advertiser's web page. Thus, while such user interest would not have previously been recorded, since it did not rise to the level of interest required to generate a click-through, such a lower interest level can now be quantified, since it may generate a view of the second level advertisement.

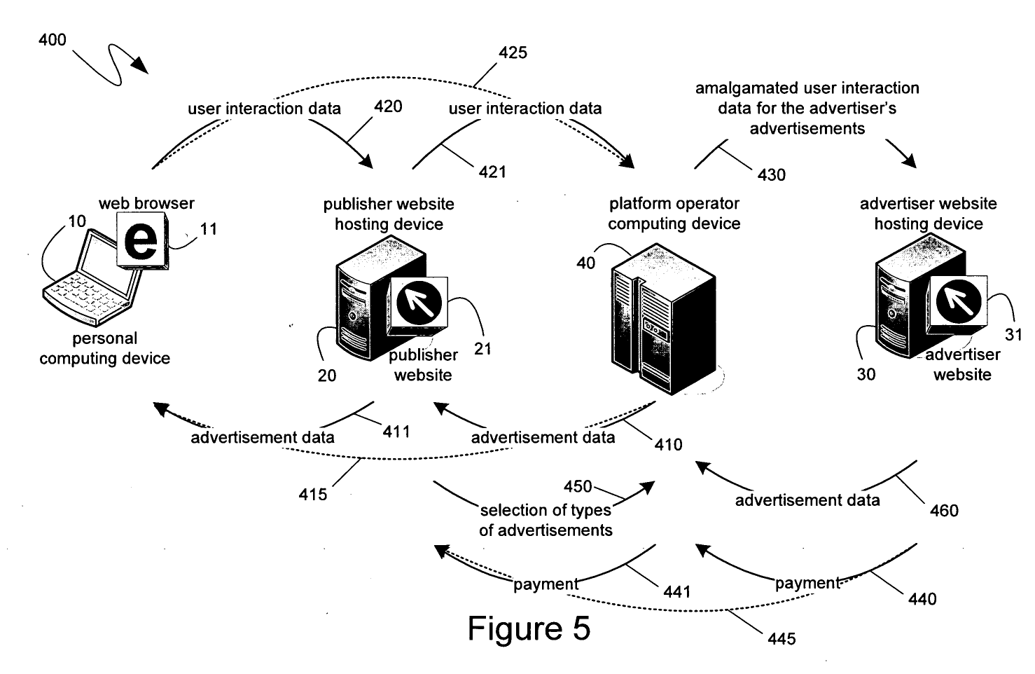

Turning to FIG. 5, an exemplary flow diagram 400 is shown, illustrating communications associated with the display of multiple levels of advertisements as shown in FIG. 4. Advertisement data can be provided from the platform operator computing device 40 to the web browser 11 on the personal computing device 10, either directly via communication 415, or by first sending the advertisement data to the publisher website hosting device 20 via communication 410 and subsequently providing the advertisement data from the publisher website computing device to the web browser via communication 411. Direct communication 415 of advertisement data can be initiated by the transmission of a web page from the publisher website 21 to the web browser 11. The web page can contain advertising links to the platform operator computing device 40, thereby causing the web browser 11 to request the advertisement data transmitted via communication 415. Indirect communications 410 and 411, on the other hand, enable the publisher website 21 to send advertisement data to the web browser 11, via communication 411, at the same time as the rest of the content of the requested web page. In one embodiment, the communications 410 and 411, or 415, can transmit all of the advertising data for an ad package at the same time, thereby caching multiple levels of advertisements at the web browser 11 for faster display. In an alternative embodiment, the communications 410 and 411, or 415, can initially transmit only a first level advertisement and can transmit subsequent levels of advertisements once those levels are needed by the web browser 11, such as in response to triggering actions by the user.

If the user of the web browser 11 performs an action that causes one or more subsequent level advertisements to be displayed, the web browser 11 can communicate such an event back to the platform operator computing device, either directly via communication 425 or indirectly by first notifying the publisher website hosting device 21, via communication 420, and subsequently the publisher website hosting device can notify the platform operator computing device via communication 421. In one embodiment, communications 420 and 421, or 425, can occur on a real-time basis. For example, the web browser 11 can have received only a first level ad 61 of the ad package 60, and communications 420 and 421, or 425, can comprise requests for subsequent level advertisements. In another embodiment, communications 420 and 421, or 425, can occur on a delayed basis. For example, the display of subsequent level advertisements from an ad package 60 can be recorded in a file, known as a “cookie,” stored on the personal computing device 10. Information from the cookie can be obtained by the platform operator computing device 40 or the publisher website hosting device 20 at a subsequent time via communications 420, 421 or 425.

The platform operator computing device 40 can collect user interaction data from multiple personal computing devices and multiple publisher website hosting devices. The amalgamated user interaction data can then be provided to the advertiser via communication 430. It can also be provided to the publisher if such data is not already available to the publisher from communications 420. The amalgamated user interaction data provided to the advertiser can be advertiser-specific, such that each advertiser receives user interaction data regarding their advertisement packages. For each advertisement package, the data provided can include such information as the number of times that a first level ad was displayed, the number of times each successive level advertisement was displayed and the number of times that the viewer ultimately clicked through to the advertiser's web site or other advertiser location.

In one embodiment, the amalgamated user interaction data can be used as the basis for the financial agreement between the advertiser and the publisher of the web pages that display the advertiser's advertisements. Because multiple levels of advertisements can be displayed, a more gradually tired financial agreement can be used than would have otherwise been possible. For example, rather than paying a very low amount for mere advertisement views, and a higher amount for much rarer advertisement click-throughs, advertisers can pay gradually increasingly higher amounts for each higher advertising level that is displayed to a particular viewer of the web page. Consequently, the exact payment levels can be set in such a manner to more accurately reflect the overall value of each successive level to the advertiser.

Payments from the advertiser in accordance with the financial agreements reached can be provided as illustrated by payments 440 and 441, or 445 of FIG. 5. In one embodiment, the advertiser can provide payment 440 to the platform operator computing device for all of the ad packages hosted by that platform operator. The platform operator can, subsequently, forward along the share of the payment 440, as payment 441, to the respective publishers whose web pages hosted those ad packages. In another embodiment, the advertiser can provide payment 445 directly to the publisher for the advertiser's ad packages hosted by the publisher's web pages.

The amalgamated user interaction data can also be used to tune the ad packages. In one embodiment, the advertiser can use the amalgamated user interaction data to better understand potential customer's reactions to specific advertising elements. For example, if the amalgamated user interaction data illustrated that a sizeable percentage of users who viewed a second level ad also viewed a third level ad, the advertiser can model further advertisements after that second level ad, even if the rest of the ad package was not empirically shown to be successful. Similarly, if the amalgamated user interaction data further illustrated that a very small percentage of users who viewed a third level ad ultimately clicked-through to the advertiser's web site, the advertiser can modify only that third level ad, leaving the remaining advertisements in the ad package unchanged. Thus, as can be seen, user interaction data for multiple levels of advertisements provides the advertiser information regarding specific elements of advertisement campaigns, enabling the advertiser to modify only those elements. Consequently, the advertisers can tune their advertisements in a more precise manner. Such tuned advertisements can then be provided to the platform operator computing device 40 via communication 460 for subsequent display to web page visitors.

Publishers can likewise more accurately tune the advertisements that they display. More specifically, user interaction data for multiple levels of advertisements provides a more precise measurement of users' interest in an advertisement. For example, users that perform a triggering action to display a second level advertisement, but then do not trigger a third level advertisement can be deemed to be less interested in the ad package than those users that proceed to view the third level ad. With the user interaction data for multiple level ad packages, publishers can determine which types of ad packages were the most interesting to the greatest amount of users, or which advertiser's ad packages were the most interesting to the greatest amount of users. Consequently, the publishers can select, for future display on their web pages, ad packages advertising specific types of products or services, or ad packages from particular advertisers. Such a selection can be communicated to the platform operator computing device 40 via communication 450, as shown in FIG. 5.

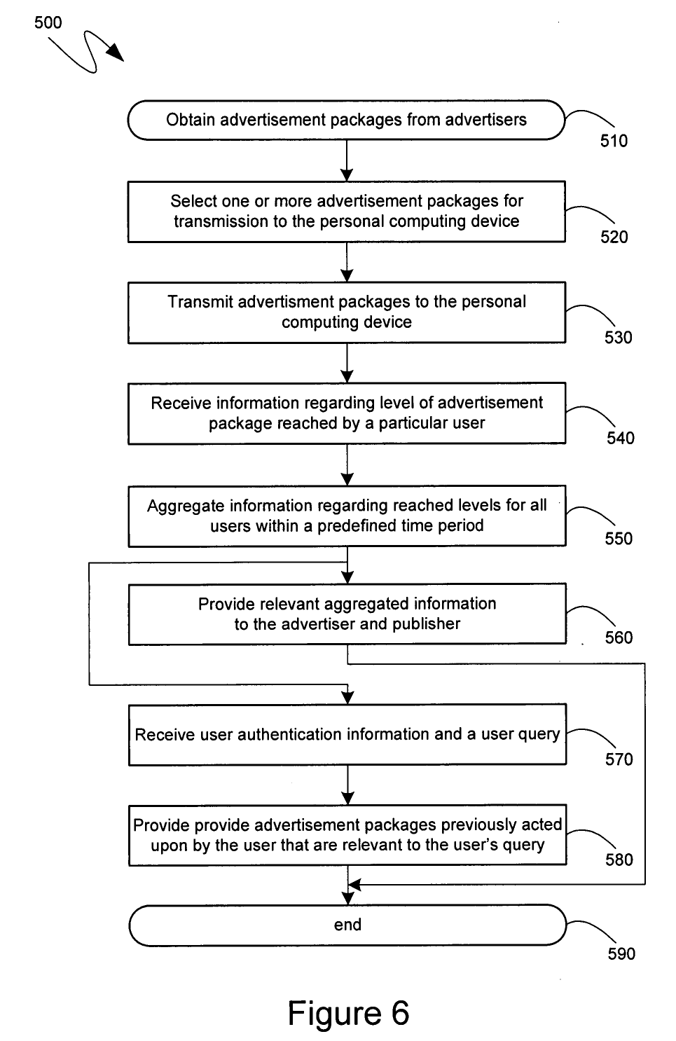

Turning to FIG. 6, a flow diagram 500, illustrating the steps performed by the platform operator, is shown. As indicated, at step 510, the platform operator can receive ad packages from advertisers. When a request is received to display one or more ad packages on a web page, the platform operator can, at step 520, select one or more of the ad packages previously received at step 510 and can, at step 530, transmit them to a personal computing device 10, executing a web browser 11, displaying the web page. As indicated previously, the platform operator computing device 40 can transmit ad packages to the personal computing device 10 either by communicating with the personal computing device, or by transmitting the ad packages to the publisher's computing device 20 first and enabling the publisher computing device to transmit the ad packages to the personal computing device at the same time that the remaining web page data is transmitted.

Once the ad packages have been sent to the personal computing device 10, information regarding the user's actions with respect to those ad packages can be received by the platform operator as shown at step 540. As indicated previously, the user's actions can be reported via a number of mechanisms. For example, each level of advertisement of an ad package can be requested individually by the web browser 11, and each such request implicitly indicates the level of advertisement that is being displayed to a particular user. Alternatively, data regarding the level of advertisement displayed to a user by the web browser 11 can be stored in a cookie at the web browser, and can be subsequently read by the platform operator.

Data from each individual user's experiences with an ad package 60 can be amalgamated at step 550 and the data relevant to the ad packages for a particular advertiser can be provided to the advertiser at step 560. Step 560 can likewise entail the provision of publisher-specific user interaction data to the publisher so as to enable the publisher to tune the types of advertisements their viewers are presented.

The platform operator can likewise maintain the user interaction data on a user-specific basis to provide value-added features for individuals users that can be offered by one or more publisher's web pages. In one embodiment, a value-added feature that can be provided to visitors based on the user interaction data is an ability to review or search advertisements that were previously presented to the visitor. Such a value-added feature can be especially useful in the context of a search web page. For example, if the exemplary web page 200 was a web page providing the results of a search, the ad packages displayed in advertisement areas 230 and 240, among others, could be associated with the terms that were searched for in order to display that search results web page. A search for “spark plug,” for example, could result in the presentation of ad packages from auto manufacturers.

The correlation between search terms and displayed ad packages can make value-added features, such as the ability to review or search previously presented advertisements, more useful. For example, a search web page visitor may remember that they viewed several layers of an ad package that was of interest to them, but cannot remember its exact content. If the search web page visitor can remember the search terms that they were searching for when they saw the ad package, the individual user interaction data maintained by the platform operator can identify the advertisement packages that were presented to the search web page visitor in connection with that search. Conversely, a search web page visitor might remember one or more levels of an ad package that they were presented with, but cannot recall the exact search terms that the visitor used. If the visitor wishes to perform the search again, so as to visit a link that was returned as a search result, the platform operator can reference the user-specific user interaction data and identify the search terms used when the visitor was presented the ad package they remembered.

The maintenance of user-specific user interaction data enables value-added features that are also relevant outside of the context of search web pages. For example, a value-added feature that can be provided by any type of web page is an automatically generated list of the advertisement packages for which a user triggered at least a third level advertisement to be displayed. Such as list can be offered to be emailed to individuals of the user's choosing as the user's gift wish list. Alternatively, such a list can be useful to the user as a supplement to the web browser's history list, which traditionally would only include individual web pages, and not the advertisements viewed therein.

Turning back to FIG. 6, such value-added features can be provided to a user at step 580. However, because such user-specific user interaction data can contain sensitive information that the user may not desire to have publicly known, an authentication mechanism can be implemented at step 570 to ensure that the user whose ad interaction data is being referenced has first been appropriately authenticated. Subsequently, at step 580, a user query can be received and responded to by searching the user-specific user interaction data for the relevant information.

As can be seen from the above descriptions, multiple levels of advertisements from a single ad package can be presented in response to triggering actions, enabling a more accurate assessment of a viewer's interest. In view of the many possible variations of the subject matter described herein, we claim as our invention all such embodiments as may come within the scope of the following claims and equivalents thereto.

We claim:

1. One or more computer-readable media comprising a multi-level advertising package associated with an advertiser and directed to an advertised element, the multi-level advertising package comprising:
a first level advertisement comprising a first display data for presentation within an application-generated context directed to a user-initiated, non-advertising task, and an indication of a first triggering event; and
a subsequent level advertisement for presentation in response to the first triggering event, the subsequent level advertisement comprising a subsequent display data for presentation within the same application-generated context and providing more information regarding the advertised element than the first display data, and an indication of a subsequent triggering event.

2. The computer-readable media of claim 1, wherein the application-generated context is a web browser context generated by displaying a web page unaffiliated with the advertiser.

3. The computer-readable media of claim 1, wherein the application generated context is an advertisement-sponsored application context, wherein the advertisement-sponsored application is directed to non-advertising tasks.

4. The computer-readable media of claim 1, wherein the first triggering event is a cursor hover over a first display area comprising presentation of the first display data.

5. The computer-readable media of claim 1, wherein the subsequent triggering event is a click in a second display area comprising presentation of the subsequent display data.

6. The computer-readable media of claim 1, wherein the subsequent triggering event causes the application-generated context directed to the user-initiated, non-advertising task to be superceded by an advertiser-generated context.

7. One or more computer-readable media comprising computer-executable instructions providing for the display of at least one level of a multi-level advertising package associated with an advertiser and directed to an advertised element, the computer-executable instructions directed to steps comprising:
displaying a first level advertisement within an application-generated context directed to a user-initiated, non-advertising task;
detecting a first triggering event associated with the first level advertisement;
displaying a subsequent level advertisement in response to the first triggering event within the same application-generated context and providing more information regarding the advertised element than the first level advertisement;
and detecting a subsequent triggering event.

8. The computer-readable media of claim 7 comprising further computer-executable instructions directed to recording a highest level advertisement of the multi-level advertising package displayed to a user.

9. The computer-readable media of claim 8 comprising further computer-executable instructions directed to recording a user identification associated with the highest level advertisement displayed to the user.

10. The computer-readable media of claim 7, wherein the application-generated context is a web browser context generated by displaying a web page unaffiliated with the advertiser.

11. The computer-readable media of claim 7, wherein the application generated context is an advertisement-sponsored application context, wherein the advertisement-sponsored application is directed to non-advertising tasks.

12. The computer-readable media of claim 7, wherein the first triggering event is a cursor hover over the displayed first level advertisement.

13. The computer-readable media of claim 7, wherein the subsequent triggering event is a click in a second display area comprising presentation of the subsequent display data.

14. The computer-readable media of claim 7, wherein the subsequent triggering event causes the application-generated context to be superceded by an advertiser-generated context.

15. One or more computer-readable media comprising computer-executable instructions for recording the display of at least one level of a multi-level advertising package associated with an advertiser and directed to an advertised element, the computer-executable instructions directed to steps comprising:
transmitting the multi-level advertising package to a web browser displaying a publisher's web page;
receiving information regarding a highest level advertisement of the multi-level advertising package displayed to a visitor of the publisher's web page;
receiving at least one of: a publisher identifier for the publisher; a web page identifier for the web page; and a visitor identifier for the visitor;
associating the at least one of the publisher identifier, the web page identifier and the user identifier with the highest level advertisement displayed to the visitor; and
receiving a request from the visitor regarding the highest level advertisement displayed to the visitor.

16. The computer-readable media of claim 15, wherein the request comprises an identification of the advertised element, and wherein the web page identifier is provided in a response.

17. The computer-readable media of claim 15, wherein the request comprises the web page identifier, and wherein the information regarding the highest level advertisement displayed to the visitor is provided in a response.

18. The computer-readable media of claim 15 comprising further computer-executable instructions directed to providing, to the advertiser, information regarding the highest level advertisement displayed to the visitor.

19. The computer-readable media of claim 15, wherein the multi-level advertising package comprises a first level advertisement displayed as part of the web browser's display of the publisher's web page and a subsequent level advertisement displayed, in response to the first triggering event, as part of the web browser's display of the publisher's web page.

20. The computer-readable media of claim 19, wherein the first triggering event is a cursor hover over the displayed first level advertisement.
